(19) United States
(12) Patent Application Publication
(10) Pub. No.: US 2019/0170203 A1
(43) Pub. Date: Jun. 6, 2019

(54) SPRING DEVICE

(71) Applicant: LEVITATE TECHNOLOGIES, INC., San Diego, CA (US)

(72) Inventor: Mark C. DOYLE, Del Mar, CA (US)

(21) Appl. No.: 15/731,154

(22) PCT Filed: Sep. 29, 2015
(86) PCT No.: PCT/US2015/053036

§ 371 Date: Apr. 17, 2017

Related U.S. Application Data
(60) Provisional application No. 62/056,992, filed on Sep. 29, 2014.

(51) Int. Cl. F16F 1/12; F16F 3/04; F16F 1/06

(52) U.S. Cl. CPC F16F 1/125; F16F 2236/06; F16F 1/06; F16F 3/04

(57) ABSTRACT

A spring assembly is provided that includes a spring including a plurality of coils wound helically between first and second ends of the spring; and a spring disc attached to the first end of the spring between a first end coil terminating the first end and a second end coil adjacent the first end coil. Methods for making such spring assemblies are also provided.

### RELATED APPLICATION DATA

The present application claims benefit of co-pending provisional Ser. No. 62/056,992, filed Sep. 29, 2014, the entire disclosure of which is expressly incorporated by reference herein.

### FIELD OF THE INVENTION

The present invention relates to spring devices, and more particularly to holders for coupling to ends of a spring, and to methods for making and using such spring devices.

### BACKGROUND

FIG. 1 depicts a typical extension (tension) spring 5 including spiral body coils 10, hook 12, and hook stress point 14. Extension springs serve to apply a tension load to other machine elements, and to store energy. Extension springs generally fail (break) at the hook 12, in particular at points of high stress such as hook stress point 14. Hooks 12, being relatively large, may also occupy valuable space inside of compact machinery.

Thus, an alternative way of connecting extension springs to other elements that avoids unnecessary stress points of the hooks and/or that is more compact than conventional hooks would be useful.

### SUMMARY

The present invention is directed to spring devices and, more particularly, to holders for coupling to ends of a spring, and methods for making using such devices.

In accordance with an exemplary embodiment, a spring assembly is provided that includes a spring including a plurality of coils wound helically between first and second ends of the spring; and a spring disc attached to the first end of the spring between a first end coil terminating the first end and a second end coil adjacent the first end coil.

In accordance with another embodiment, a method is provided for making a spring assembly that includes providing a spring including a plurality of coils wound helically between first and second ends of the spring, a first end coil terminating the first end and a second end coil adjacent the first end coil; and attaching a spring disc to the first end of the spring between the first and second end coils.

Other aspects and features of the present invention will become apparent from consideration of the following description taken in conjunction with the accompanying drawings.

### BRIEF DESCRIPTION OF THE DRAWINGS

The present invention is best understood from the following detailed description when read in conjunction with the accompanying drawings. It will be appreciated that the exemplary devices shown in the drawings are not necessarily drawn to scale, with emphasis instead being placed on illustrating the various aspects and features of the illustrated embodiments.

FIG. 1 is a perspective view of a conventional extension spring including hooks on its ends.

FIG. 2 is a perspective view of an exemplary embodiment of a hook-less extension spring.

FIG. 2A is a perspective view of an alternative embodiment of a hook-less extension spring including variable pitch coils.

FIGS. 3A-3D are various views of an exemplary embodiment of a spring disc.

FIG. 4A is a side view of an exemplary embodiment of a spring assembly including the spring of FIG. 2 and a pair of spring discs, such as those shown in FIGS. 3A-3D, attached to ends of the spring.

FIG. 4B is a cross-sectional view of the spring assembly of FIG. 4A taken along line 4A-4A.

FIG. 4C is an end view of the spring assembly of FIG. 4A.

FIG. 5A is a side view of the spring assembly of FIG. 4A with a connector element coupled to one of the spring discs.

FIG. 5B is a cross-sectional view of the spring assembly of FIG. 5A taken along line 5A-5A.

FIG. 5C is a detail of one end of the spring assembly of FIG. 5A.

FIG. 5D is an end view of the spring assembly of FIG. 5A.

FIGS. 6A and 6B are perspective views of a spring assembly in unextended and extended positions, respectively.

FIG. 7 is a perspective view of an exemplary embodiment of an arm support system that may include a spring assembly, such as that shown in FIG. 4A.

### DETAILED DESCRIPTION OF THE EXEMPLARY EMBODIMENTS

Turning to the drawings, FIGS. 2-6B show an exemplary embodiment of a spring assembly 100 that includes a hook-less extension spring 20 and a pair of spring discs 30 coupled to respective ends of the spring 20.

FIG. 2 shows an exemplary embodiment of a hook-less extension spring 20 including a plurality of spiral body coils 22 formed from wire 26 having two coil ends 24. Each coil end 24 includes a first end coil 27 at the very end terminating at the end of the wire 26 and a second end coil 28 adjacent the first end coil 27. In a relaxed or lowest energy state, adjacent coils may abut one another, e.g., to provide a closed spring in its low energy state, yet may be resiliently separated, e.g., by extending the ends 24 away from one another. Alternatively, as shown in FIG. 2A, the first and second end coils 27,′ 28′ may be spaced apart from one another in a relaxed state to define a predefined gap 29,′ while the remaining coils 22′ may abut one another, which may facilitate installation of the spring disc (not shown) between the first and second end coils 27,′ 28.′ In exemplary embodiments, the spring 20 may be formed from a variety of materials, e.g., metal, plastic, and the like, having desired elasticity and/or other mechanical properties.

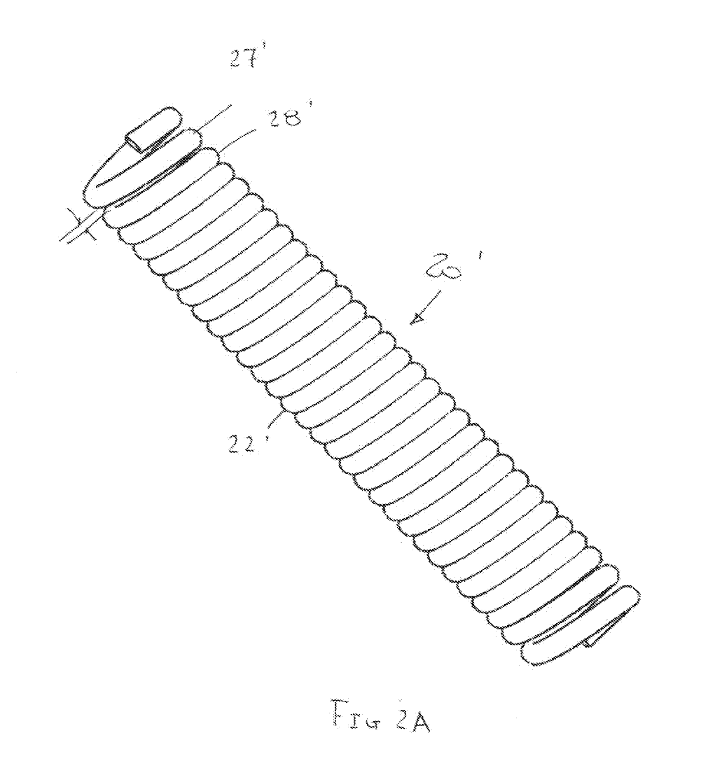

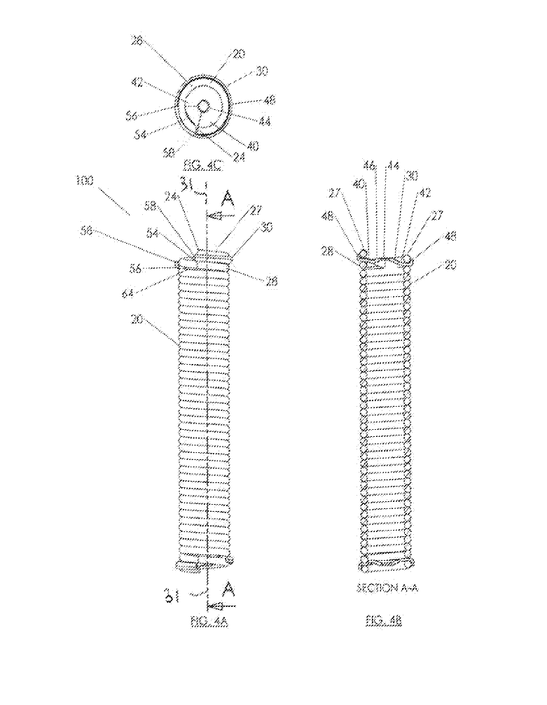

Turning to FIGS. 3A-3D, an exemplary embodiment of a spring disc 30 is shown that includes attachment feature 44, optional boss 46, optional rim 48, notch 54, low surface 42, high surface 40, low notch end 56, and high notch end 58. Attachment feature 44 may be a hole, threaded hole, tab, hook, or other securing feature, e.g., for coupling the end of the spring assembly 100 to a cable or other element, e.g., along central axis 31.

The spring disc 30 generally includes an at least partial annular disc with the low surface 42 offset around the circumference of the disc from the high surface 40 such that the notch 54 separates the high and low surfaces 40, 42, as shown in FIG. 3B. As can be seen in FIGS. 3A and 3C, the disc 30 has a spiral or helical shape such that the disc 30 extends out of an imaginary plane perpendicular to the central axis 31. In this manner, the low surface 42 may be offset along the central axis 31 relative to the high surface sufficiently to facilitate the joining of the spring disc 30 to the hook-less spring 20, as described below. For example, the low surface 42 may be lower than the high surface 40 by approximately the diameter of the wire 26 in the hook-less spring 20, e.g., between about 3-4 mm. In addition, the disc 30 may have a substantially uniform pitch or slope between the high surface 40 and the low surface 42, e.g., corresponding to the pitch of the end coils of the spring 20. FIG. 3D presents a cross-sectional view of the spring disc 30, taken along line A-A of FIG. 3B, showing the high surface 40 in relation to the low surface 42.

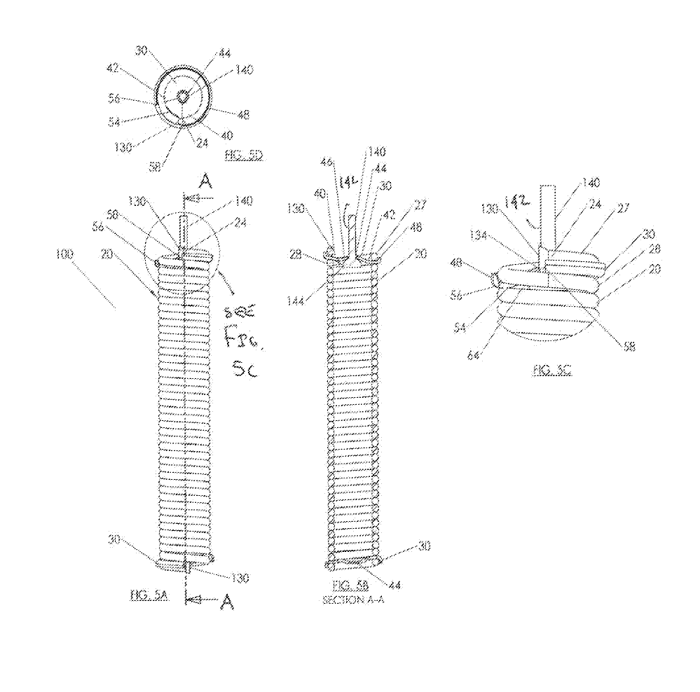

Turning to FIGS. 4A-4C, an exemplary embodiment of a spring assembly 100 is shown that includes a pair of spring discs 30, such as that shown in FIGS. 3A-3D, coupled to a hook-less spring 20, such as that shown in FIG. 2. As shown, a spring disc 30 may be inserted into each end of the hook-less spring 20, e.g., in between first end coil 27 and second end coil 28 at the very end of the spring 20. The notch 54 in the spring disc 30 provides a passageway for the first end coil 27 (above the spring disc 30) to transition into the second end coil 28 (below the spring disc 30). The spring disc 30 may spread the end coils 27 and 28, resulting in a gap 64, as shown in FIG. 4A. Alternatively, gap 64 may be formed into the hook-less spring 20 at the time of manufacture, for example, by forming the hook-less spring 20 with a space between the first end coil 27 and the second end coil 28.

Optionally, a rim 48 may be provided around the outer perimeter of the spring disc 30, e.g., extending upwardly from the top surface, which may keep the spring disc 30 substantially concentric with the hook-less spring 20 and the central axis 31, e.g., by preventing the spring disc 30 from moving away from the center of the hook-less spring 20. The rim 48 may be formed after the spring disc 30 is joined to the hook-less spring 20, for example, by crimping or upsetting a portion of the spring disc 30, or the rim 48 may be preformed in the spring disc 30. As best seen in FIG. 3B, the rim 48 may extend substantially continuously around the perimeter of the spring disc 30 between the low notch end 56 and the high notch end 58, although alternatively, the rim 48 may be intermittent, e.g., defined by a plurality of tabs (not shown) spaced apart from one another around the perimeter of the spring disc 30.

In addition or alternatively, an optional boss 46 may be provided, e.g., around the hole 44, which may also maintain the spring disc 30 substantially concentric with the hook-less spring 20. The spring disc 30 may be formed using a variety of materials, e.g., metal or plastic, and/or methods, e.g., stamping, machining, molding, and the like. For example, the nonplanar shape and/or features of the spring disc 30 may be formed when the spring disc is molded, machined or otherwise formed, or the spring disc 30 may be formed from a planar base and then the nonplanar shape may be formed into the base.

FIG. 4B is a cross-sectional view of the spring assembly 100 taken along line A-A in FIG. 4A, and shows the first end coil 27 lying substantially in contact with the high surface 40 and the low surface 42 of the spring disc 30, which together approximate the spiral shape of the first end coil 27. Again, optional rim 48 and/or boss 46 may act to keep the spring disc 30 substantially concentric with the hook-less spring 20.

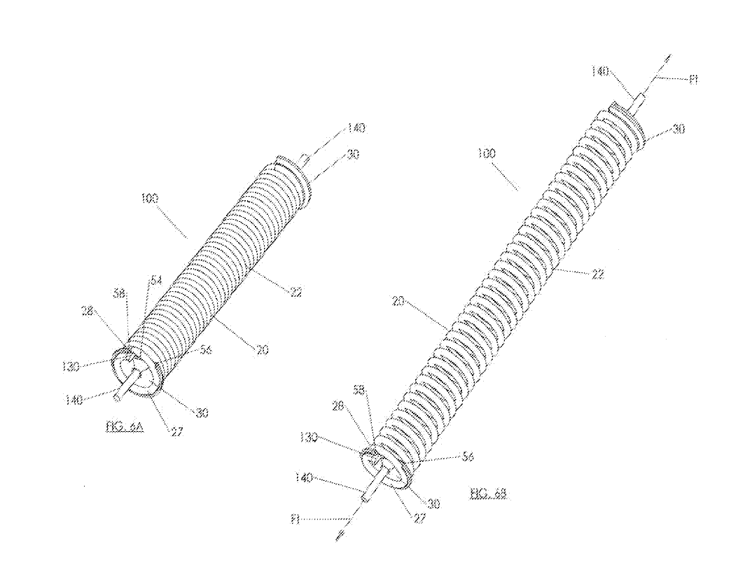

FIGS. 5A and 5B show the spring assembly 100 with the tip 24 of the first end coil 27 (best seen in FIG. 2) deformed to provide an optional tab end 130, which may interfere with high notch end 58, preventing the spring disc 30 from rotating out of the hook-less spring 20 (e.g., preventing it from “unscrewing” itself out of the hook-less spring 20). Alternatively, a notch or other feature (not shown) may be created in the first end coil 27 to prevent movement of the spring disc 30 once installed. FIG. 5C provides a magnified view of the optional tab end 130 interfering with the high notch end 58.

Other features that interfere with, or attach to, a portion of the spring disc 30 to keep it from rotating out of the hook-less spring 20 may also be provided. For example, the coil end 24 may be bent sideways or downwards, or the first end coil 27 may be fastened to the spring disc 30 with a fastener, e.g., a clip, wire, or screw (not shown), and/or may be bonded with adhesives, or may be welded, soldered, and/or fused to the spring disc 30. The spring disc 30 may also be fixed to other machine elements in a way that prevents the spring disc 30 from rotating, thus preventing it from rotating out of the hook-less spring 20.

Optional fastening element 140 may extend from one or both spring discs 30 (only one shown in FIGS. 5A and 5B for simplicity), which may be a fastener, cable, or other suitable attachment element. The fastening element 140 may include an elongate shaft 142 terminating in an enlarged portion 144, which may interfere with (or otherwise connect to) the hole or attachment feature 44, and allow the fastening element 140 to apply tensile loads to the spring disc 30 (which, in turn, may apply a tensile load to the first end coil 27, and thus the entire hook-less spring 20). For example, the fastening element 140 may include a cable, pin, or other elongate member 142 with an enlarged integral head 144. Alternatively, instead of an integral head 144, a separate nut or other element (not shown) that may be threaded onto the end of the elongate member 142. In an exemplary embodiment, an elongate member may be coupled to each end of the spring to couple the spring to other components of a mechanical device, such as an arm support system, such as that shown in FIG. 7 and/or as disclosed in U.S. Publication Nos. 1012/0184880 and 2014/0158839, the entire disclosures of which are expressly incorporated by reference herein.

The free end of the shaft 142 may be coupled to a cable or other machine element (not shown), e.g., using cooperating connectors, fasteners, threads, welding, soldering, and the like (also not shown). Alternatively, an end of a cable or other machine element may be coupled directly to the spring disc 30, e.g., through the hole or other attachment feature 44.

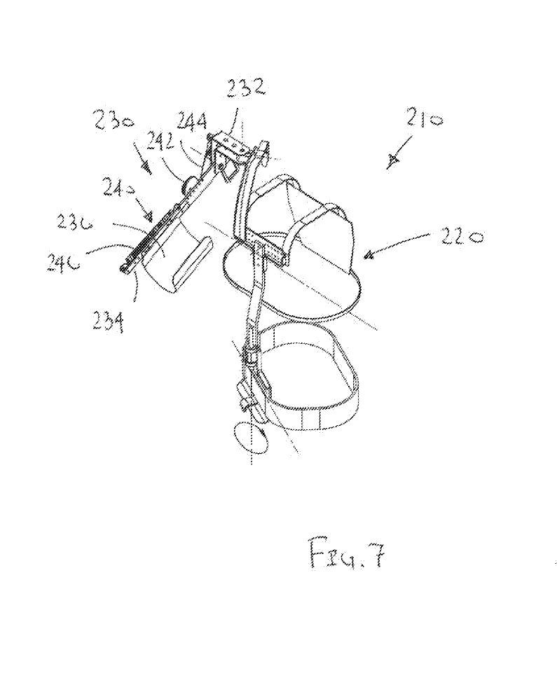

FIG. 6A shows the spring assembly 100 with a spring disc 30 and fastening element 140 installed at each end, and the spring 20 in a relaxed (unloaded) or other low energy state. FIG. 6B shows the spring assembly 100 extended under tensile axial force Ft, which acts on the spring disc 30 through the fastening element 140. The spring disc 30 in turn acts to apply an axial load to the first end coil 27, which in turn transmits the load to the rest of the coils 22.

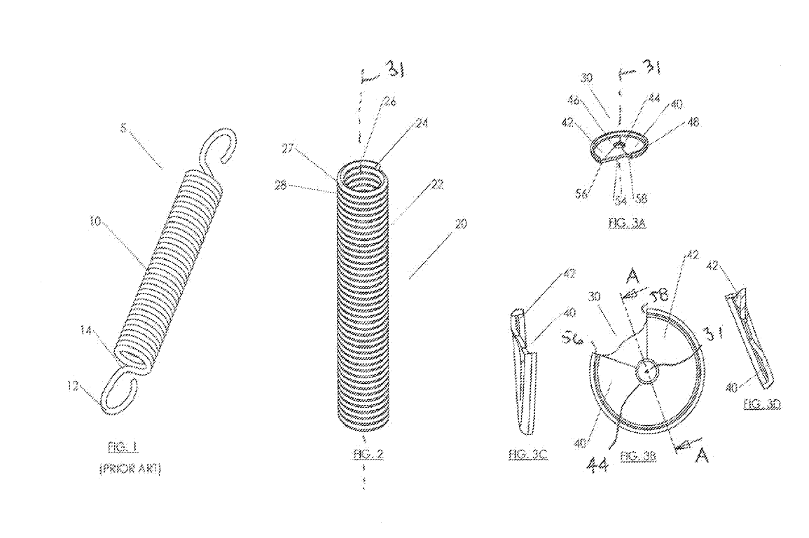

Using the spring disc 30, a cable or other fastening element may be coupled directly to the ends of the spring 20 thereby minimizing wasted space adjacent the spring 20. In addition, the spring disc 30 may distribute forces on the ends of the spring 20 onto the perimeter of the first end coil 27, thereby reducing the risk of spring failure as may occur with conventional spring hook ends (as shown in FIG. 1).

Turning to FIG. 7, an exemplary embodiment of an arm support system 210 is shown that includes one or more spring assemblies, which may be similar to those described elsewhere herein. Generally, the system 210 includes a torso mounted harness 220, and one or more adaptive arm supports 230 (only one shown) coupled to the harness 220. The adaptive arm support 220 may be biased with a resilient element (e.g., including a spring assembly similar to those described elsewhere herein) and/or other components, to impart a desired force to the arm of a user (not shown), for example, to bear all, or part of, the weight of the arm. The force may vary with arm position or be substantially constant through its range of motion.

In the embodiment shown in FIG. 7, the arm support 230 includes a first arm support segment 232 pivotally coupled to the harness 220 about a first vertical axis such that the first arm support segment 232 is rotatable substantially horizontally about the first vertical axis relative to the harness 220, and a second arm support segment 234 pivotally coupled to the first arm support segment 232 such that the second arm support segment 234 is rotatable about a second axis generally orthogonal to the first vertical axis. Optionally, the second arm support segment 234 may carry an arm rest 236 and/or other component for receiving the user's arm.

In addition, the arm support 230 includes one or more compensation elements 240, e.g., including a pulley arrangement 242 mounted on the second arm support segment 234 and a cable 244 wrapped partially around the pulley 242 and including a first end coupled to a resilient member 246, e.g., a spring assembly similar to those described elsewhere herein, and a second coupled to the first arm support segment 232 such that at least a portion of a force from the resilient member is applied to the second arm support segment 232 to the generate the offset force.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A spring assembly comprising:
a spring including a plurality of coils wound helically between first and second ends of the spring; and
a spring disc attached to the first end of the spring between a first end coil terminating the first end and a second end coil adjacent the first end coil.

2. The spring assembly of claim 1, wherein the spring disc further comprises a notch in a portion of the periphery of the disc that receives a transition region of the spring between the first end coil and the second end coil.

3. The spring assembly of claim 1, wherein the spring disc further comprises a rim extending around a portion of the first end coil to secure the spring disc relative to the first end of the spring.

4. The spring assembly of claim 1, wherein the spring disc comprises an attachment feature for coupling a connector element to the first end of the spring.

5. The spring assembly of claim 4, wherein the attachment feature comprises a hole through the center of the spring disc.

6. The spring assembly of claim 5, further comprising an elongate connector member comprising a first end received through the hole and an enlarged head for preventing removal of the connector member first end from the hole.

7. The spring assembly of claim 1, further comprising a second spring disc attached to the second end of the spring between a first end coil terminating the second end and a second end coil adjacent the first end coil.

8. The spring assembly of claim 1, wherein the spring comprises an extension spring.

9. The spring assembly of claim 1, wherein the spring disc comprises a surface that extends at least partially across the diameter of the first end of the spring, and a rim extending at least partially around a periphery of the surface.

10. The spring assembly of claim 9, wherein the surface has a helical or spiral shape.

11. The spring assembly of claim 1, further comprising a feature on an end tip of the first end coil that engages the spring disc to lock the spring disc relative to the spring.

12. The spring assembly of claim 1, further comprising a feature on an end tip of the first end coil that engages the spring disc to prevent movement of the spring disc relative to the spring.

13. The spring assembly of claim 11 or 12, wherein the feature comprises a crimped tab formed in the end tip.

14. The spring assembly of claim 11 or 12, wherein the feature comprises a fastener on the end tip.

15. The spring assembly of claim 11 or 12, wherein the end tip is attached to the spring disc by one of bonding with adhesive, soldering, welding, or fusing.

16. A spring assembly comprising:
a spring including a plurality of coils wound helically between first and second ends of the spring, the first end terminating at a first end coil and including a second end coil adjacent the first end coil;
a first spring disc comprising a helical or spiral surface secured between the first end coil and the second end coil, and a hole extending through the surface; and
a first elongate member coupled to the first spring disc via the hole for coupling the spring assembly to a machine element.

17. The spring assembly of claim 16, wherein the second end terminates at a third end coil and includes a fourth end coil adjacent the third end coil, the spring apparatus further comprising:
a second spring disc comprising a helical or spiral surface secured between the third end coil and the fourth end coil, and a hole extending through the surface; and
a second elongate member coupled to the second spring disc via the hole for coupling the spring assembly to a machine element.

18-20. (canceled)

21. The spring assembly of claim 1 or 16, wherein the coils of the spring have variable pitch along its length.

22. The spring assembly of claim 21, wherein the first and second end coils on each end of the spring are spaced apart from one another in a relaxed state and the remaining coils abut one another.

23. A method for making a spring assembly, comprising:
providing a spring including a plurality of coils wound helically between first and second ends of the spring, a first end coil terminating the first end and a second end coil adjacent the first end coil; and
attaching a spring disc to the first end of the spring between the first and second end coils.

24-26. (canceled)

27. A system for supporting an arm of a user, comprising:
a harness configured to be worn on a body of a user;
an arm support coupled to the harness configured to support an arm of the user, the arm support comprising an arm bracket including an arm rest on a first end thereof, and a second end pivotally coupled to the harness such that the arm bracket is pivotable about multiple axes to accommodate movement of the user's arm while following the movement without substantially interfering with the movement of the user's arm; and
one or more compensation elements mounted on the arm bracket to at least partially offset a gravitational force acting on the user's arm as the user moves and the arm bracket follows the movement of the user's arm,
wherein the one or more compensation elements comprise a spring assembly comprising:
a spring including a plurality of coils wound helically between first and second ends of the spring; and
a spring disc attached to the first end of the spring between a first end coil terminating the first end and a second end coil adjacent the first end coil.
